(19) United States
(12) Patent Application Publication
(10) Pub. No.: US 2022/0041475 A1
(43) Pub. Date: Feb. 10, 2022

(54) BRINE RECIRCULATION IN A MEMBRANE SYSTEM

(71) Applicant: Fluid Equipment Development Company, LLC, Monroe, MI (US)

(72) Inventor: Eli Oklejas, Newport, MI (US)

(73) Assignee: Fluid Equipment Development Company, LLC, Monroe, MI (US)

(21) Appl. No.: 17/393,550

(22) Filed: Aug. 4, 2021

Related U.S. Application Data
(60) Provisional application No. 63/061,237, filed on Aug. 5, 2020.

(51) Int. Cl. C02F 1/44

(52) U.S. Cl. CPC C02F 1/441; C02F 2103/08; C02F 2303/10

(57) ABSTRACT

A reverse osmosis system that utilizes the energy in the brine stream to improve the efficiency of the system.

### BACKGROUND OF THE INVENTION

Reverse osmosis (RO) systems use a membrane to separate a stream of liquid (feed) containing dissolved solids into two stream—one essentially pure liquid (permeate) and the other stream containing concentrated dissolved solids (brine). Although brine implies a salt solution, the meaning here is a solution containing any dissolved solids such as sugar.

In some cases, the amount of permeate extracted from a given volume of feed can be increased by recirculating a portion of the brine with the incoming feed to the membrane. This is called brine recirculation. The pressure differential between the feed at the membrane inlet and the brine at the membrane outlet is small, ranging typically from about 0.5 bar to 3 bar. The pressure differential is created by flow resistance through the closely spaced membrane channels as well as foulants that may accumulate within the channels over an extended period of operation.

Brine recirculation is often required for membrane systems operating at extremely high pressures, often exceeding 100 bar. Pumps that recirculate the brine must be rated for such pressures and require expensive shaft seals that are prone to failure. These pumps also require special motors to handle high thrust loads generated by the high working pressure thus can suffer premature bearing failure. Also, variable frequency drives (VFDs) and/or control valves are required to allow variations in recirculation flow rates which add expense and complexity to the system.

FIG. 1 shows a standard RO system. Feed enters high pressure pump 2 through pipe 1. Pump 2 pressurizes feed and discharges through pipe 4 into membrane 10. Control valve 3 may be used to regulate feed pressure and flow rate. Permeate exits membrane 10 through pipe 11. Permeate is at low pressure having lost pressure passing through the RO membranes. Feed pressure and flow can also be controlled by regulating the speed of pump 2 using a Variable Frequency Drive (VFD) (not shown) thus eliminating the need for control valve 3. Brine exits membrane 10 through pipe 12 and control valve 15. Depressurized brine is disposed in drain 16.

Valves in these systems are often required to handle a very high pressure differential. Globe valves are preferred for such applications due a low potential for fluid cavitation and precise flow adjustment. A v-notch ball valve can be used for applications with lower differential pressures. This disclosure assumes that the appropriate valve types is used based on flow and differential pressure.

FIG. 2 shows a system like FIG. 1 with the same components with the addition of circulation pump 22 that pumps a portion of the brine from membrane 10 through pipes 12 and 24 into feed pipe 4 between control valve 3 and membrane 10. The combined flows from pump 2 and circulation pump 22 enters membrane 10. The amount of recirculated brine ranges from 10% to 90% of the brine exiting membrane 10 depending on the process requirements.

FIG. 3 shows a system like FIG. 1 with the same components that includes provisions for brine recirculation without a circulation pump. Pipe 12 conveys brine from membrane 10 through pipe 24 through control valve 25 to pipe 1 and then to pump 2. Pump 2 handles the total flow of feed plus the recirculated brine. The balance of brine flow exiting membrane 10 passes through pipe 13 and control valve 15 to drain 16. This configuration eliminates the brine recirculation pump which typically generates a 1 to 3 bar boost. However, feed pump 2 must now pressurize that same volume of brine by up to 100 bar thus consuming more energy than the configuration described in FIG. 2.

FIG. 4 shows turbocharger 21 consisting of a pump section 19 and turbine section 20. Feed from pipe 1 is pressurized by high pressure pump 2 with valve 3 providing flow and pressure regulation. Feed flows through pipe 4 to pump section 19 of turbocharger 21 to membrane 10 through pipe 9. Pressurized brine exits membrane 10 through pipe 12 to turbine section 20 which provides energy to drive pump section 19. Depressurized brine flows to drain 16 by pipe 7. Permeate exits membrane 10 through pipe 11. The purpose of turbocharger 21 is to reduce the discharge pressure of pump 2 thus saving energy and allowing a pump with a lower pressure rating.

A relevant feature of turbocharger 21 is the absence of a shaft penetration to the atmosphere thus eliminating the potential for shaft leakage regardless of operating pressure. Also, integral brine flow control valve 17 allows adjustment of brine flow resistance and feed pressure boost to meet process requirements.

### SUMMARY OF THE INVENTION

A reverse osmosis system that utilizes the energy in the brine stream to improve the efficiency of the system.

### IN THE DRAWINGS

FIG. 1 is a side elevational view of a reverse osmosis system.

FIG. 2 is a side elevational view of a reverse osmosis system.

FIG. 3 is a side elevational view of a reverse osmosis system.

FIG. 4 is a side elevational view of a reverse osmosis system.

FIG. 5 is a side elevational view of a reverse osmosis system of the present invention.

FIG. 6 is a side elevational view of a reverse osmosis system of the present invention.

FIG. 7 is a side elevational view of a reverse osmosis system of the present invention.

FIG. 8 is a side elevational view of a pump used in the present invention.

FIG. 9 is a side elevational view of a reverse osmosis system of the present invention.

FIG. 10 is a side elevational view of a reverse osmosis system of the present invention.

FIG. 11 is a side elevational view of a reverse osmosis system of the present invention.

### DETAILED DESCRIPTION OF THE INVENTION

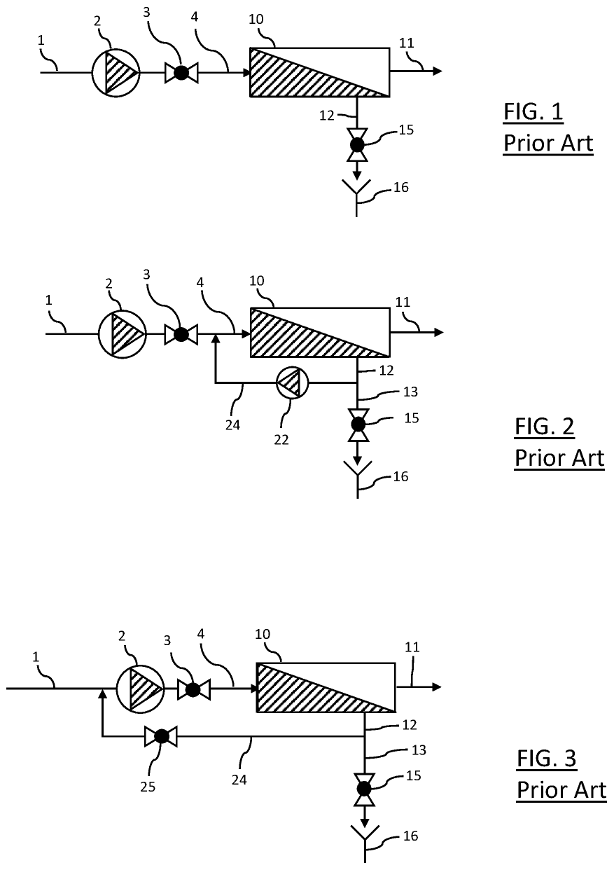

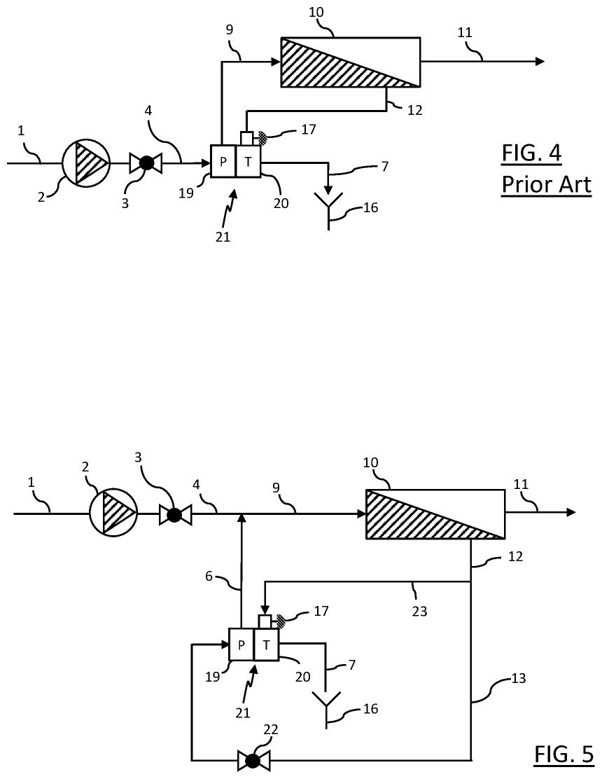

The objective of this invention is to achieve brine recirculation without a motor-driven brine recirculation pump per FIG. 2 or highly inefficient recirculation per FIG. 3 while improving the overall reliability and energy efficiency of the process.

FIG. 5 shows an embodiment of the invention. Feed passes through pipe 1, through high pressure pump 2, through control valve 3 to membrane 10 by pipes 4 and 9. Turbocharger 21 acts as a brine circulation pump. Turbine section 20 of turbocharger 21 is driven by a portion of brine exiting membrane 10 through pipe 12, through pipe 23, through turbine section 20 and disposed in drain 16 through pipe 7. Integral control valve 17 regulates brine flow as required to meet process conditions. Brine to be recirculated passes through pipe 13 to pump section 19 which pressurizes the brine to allow flow through pipe 6 into pipe 9 supplying feed to membrane 10. Recirculation flow can be regulated with valve 22 in pipe 13. Valve 3 controls the flow and pressure of the feed supplied to pipe 4. Valve 22 and valve 27 control the flow, pressure and distribution of brine supplied to pump section 19 and turbine section 20. As noted earlier, brine circulation typically requires 1 to 3 bars of pressure differential.

The above aspect of the invention provides the benefits of brine recirculation with elimination of the high-pressure shaft seal and electric motor. Also, hydraulic energy recovered from the brine stream eliminates electrical power consumption required by a motor-driven recirculation pump. However, turbochargers are most efficient when the two flow streams are relatively close in flow rates and the pressure drop through the turbine is relatively close to the pressure rise in the pump section.

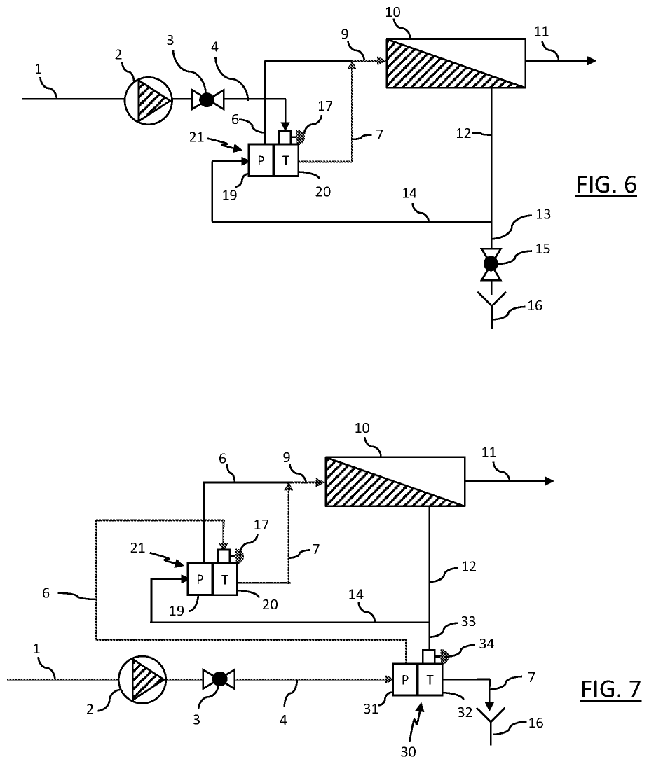

Another embodiment of the invention is illustrated in FIG. 6 that addresses the flow and pressure limitations of turbochargers. Feed flows through pipe 1 to high pressure pump 2 and through control valve 3 to turbine section 20 and turbocharger 21 through pipe 4. Feed exits turbine section 20 through pipe 7 and passes through pipe 9 to mix with recirculated brine entering membrane 10 through pipe 9. Permeate exits membrane via pipe 11. Pipe 14 directs brine from pipe 12 exiting membrane 10 to pump section 19 which provides a pressure boost sufficient to drive recirculation through pipe 6 to membrane 10 after mixing with flow form pipe 7 with the combined flow entering membrane 10 through pipe 9. Valve 3 controls the flow and pressure of the feed to turbine section 20. Valve 15 controls the flow and pressure of brine to pump section 19. The advantage over embodiment in FIG. 5 is that the turbine section 20 is handling a larger flow at a lower differential pressure that is closer to the flow and pressure differential through pump section 19 resulting in higher efficiency and more reliable operation of turbocharger 21.

A disadvantage of the foregoing embodiment is that there is no brine energy recovery as the energy to drive turbine section 20 is provided by additional discharge pressure of pump 2. FIG. 7 illustrates another embodiment which includes turbocharger 30 to recover brine hydraulic energy. Feed passes through pipe 1 to high pressure pump 2 and through control valve 3 through pipe 4 to pump section 31 of turbocharger 30 and through pipe 6 to turbine section 20 of turbocharger 21. Feed exits turbine section 20 through pipe 7 into pipe 9 which supplies feed to membrane 10. The brine to be recirculated exits brine pipe 12 through pipe 14 and passes through pump section 19 of turbocharger 21 where it is pressurized sufficiently to enter pipe 6, mixes with brine from turbine section 20 and enters membrane 10 through pipe 9. Valve 3 controls the flow and pressure of feed to pump section 31. Valve 34 controls the flow and pressure of brine to pump section 19. The foregoing embodiment allows full utilization of brine hydraulic energy via turbocharger 30 while also allowing brine recirculation using turbocharger 21.

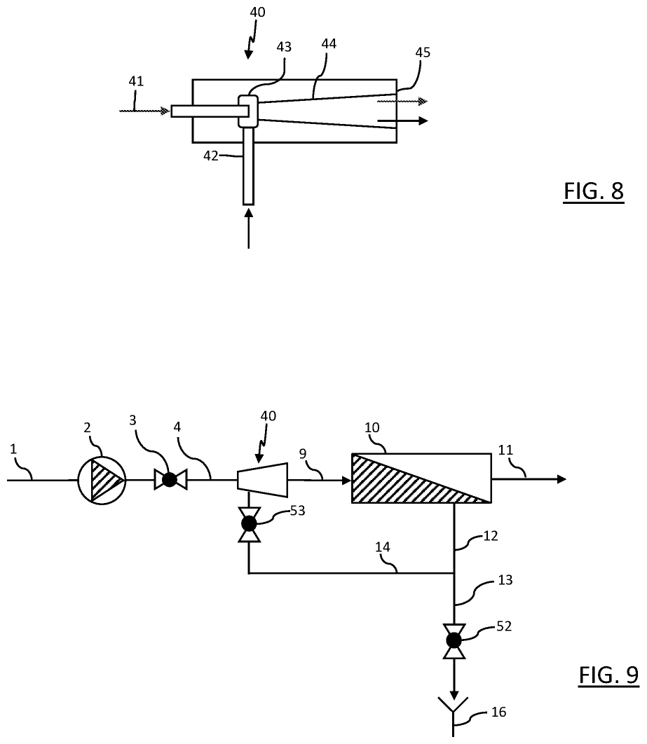

Another means to circulate brine is a venturi pump 40 as illustrated in FIG. 8. A high velocity flow (called the driving flow) enters through port 41 into mixing chamber 43. Flow to be pressurized enters the mixing chamber 43 by port 42. The flows intermingle and enter conical diffuser 44 at high velocity. Diffuser 44 reduces the flow velocity while recovering pressure thus resulting in a pressurization of the pumped fluid that exits through port 45.

FIG. 9 is another embodiment in which venturi pump 40 is used to drive brine recirculation. Feed passes through pipe 1 to high pressure pump 2 and through pipe 4 through control valve 3. The flow enters venturi pump 40 with sufficient pressure to pressurize brine entering venturi pump 40 via pipe 14. Brine exits membrane 10 through pipe 12 with the portion to be recirculated entering pipe 14 with the flow rate regulated by control valve 53. The balance of brine flow exits through pipe 13 through control valve 52 and to drain 16. Valve 52 assists in controlling the flow and pressure of the brine entering pipe 14.

A feature of this embodiment is that pump 2 pressurizes feed to membrane 10 as well as provides added pressure to drive venturi pump 40. This embodiment is typically used on systems that have flow rates too small for turbochargers to efficiently operate.

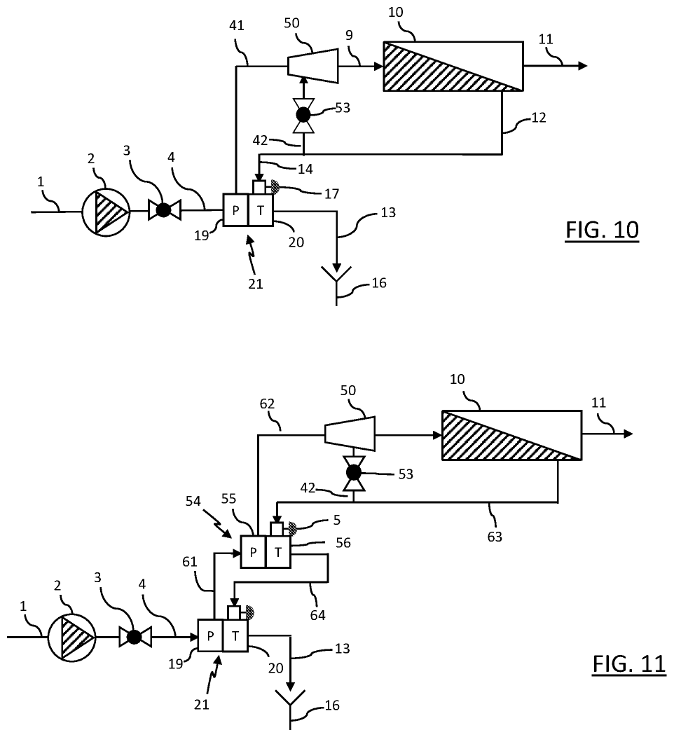

FIG. 10 is another embodiment of the invention. Feed flows through pipe 1 and is pressurized by pump 2. The flow continues through control valve 3 via pipe 4 into pump section 19 of turbocharger 21. Feed exits pump section 19 via pipe 41 with sufficient pressure to drive venturi pump 50 with remaining pressure that meets the process needs of membrane 10. Brine exits membrane 10 through pipe 12. The portion to be recirculated passes through pipe 42 and control valve 53 to venturi pump 50 where it mixes with the driving flow from pipe 41 and then passes to membrane 10. The remaining brine passes through pipe 14 to turbine section 20 and then to drain 16 through pipe 13. Valve 3 controls the flow and pressure of feed to pump section 19. Valve 53 controls the flow and pressure of brine to the venturi pump 50. Valve 17 controls the flow and pressure of brine to turbine section 20.

FIG. 11 is similar to FIG. 10 except for the addition of turbocharger 54. Turbochargers 21 and 54 are arranged in a series flow configuration. Feed passes from pipe 1 through high pressure pump 2 and through control valve 3 to pump section 19 of turbocharger 21 via pipe 4. Pressurized feed exits pump section 19 and then through pipe 61 to pump section 55 of turbocharger 54 and then through pipe 62 to venturi pump 50 and then to membrane 10. High pressure brine exits membrane 10 through pipe 63 to turbine section 56 of turbocharger 54 and then through pipe 64 to turbine section 20 of turbocharger 21 and then to drain 16 through pipe 13. Valve 3 controls the flow and pressure of feed supplied to pump section 19. Valves 53 and 5 control flow and pressure of the brine that is distributed to venturi pump 50 and turbine section 56. This arrangement is useful for extremely high-pressure operation.

Other configurations such as having three turbochargers for ultra-high pressure applications placed in series may be derived from the above invention.

The above description of the invention is given for explanatory purposes. Various changes and modifications can be made without departing from the scope of the invention as defined by the following claims.

I claim:

1. A reverse osmosis system having a high pressure pump for pressurizing a feed stream of a fluid and a membrane that separates the feed stream into a purified stream and a brine stream, the invention comprising:
an energy recovery turbocharger having a pump section with a inlet and an outlet, and a turbine section with an inlet and an outlet, the pump section being operatively connected to the turbine section, the inlet on the turbine section disposed for receiving a first portion of the brine stream from the membrane, a second portion of the brine stream being directed to the inlet of the pump section; the outlet from the pump section being connected to the feed stream from the high pressure pump, the feed stream and the discharge from the outlet of the pump section being operatively connected to an inlet for the membrane.

2. The system of claim 1 wherein a first control valve is operatively connected to the inlet on the turbine section to control the flow and pressure of the first portion of the brine stream.

3. The system of claim 1 wherein a second control valve is operatively connected to the inlet for the pump section to control the flow and pressure of the second portion of the brine stream.

4. A reverse osmosis system having a high pressure pump for pressurizing a feed stream of a fluid and a membrane that separates the feed stream into a purified stream and a brine stream, the invention comprising:
an engine recovery turbocharger having a pump section with an inlet and an outlet and a turbine section with an inlet and an outlet, the pump section being operatively connected to the turbine section, the inlet for the turbine section being disposed to receive the feed stream from the high pressure pump, the inlet for the pump section being disposed for receiving a portion of the brine stream from an outlet for the membrane, the outlet from the pump section and the outlet from the turbine section being connected to an inlet for the membrane.

5. The system of claim 4 wherein a control valve is operatively connected to the inlet for the turbine section to control the flow and pressure of the feed stream from the high pressure pump.

6. A reverse osmosis system having a high pressure pump for pressurizing a feed stream of a fluid and a membrane that separates the feed stream into a purified stream and a brine stream, the invention comprising:
a first and a second energy recovery turbocharger, the first and second turbochargers having a pump section with an inlet and an outlet and a turbine section with an inlet and an outlet, the pump section being connected to turbine section in the first and second turbo chargers, the inlet of the turbine section on the first turbocharger being disposed to receive a first portion of the brine stream, the inlet on the pump section of the first turbocharger disposed for receiving the feed stream from the high pressure pump, the outlet from the pump section of the first turbocharger being connected to the inlet of the turbine section of the second turbocharger, the inlet of the pump section of the second turbocharger disposed for receiving a second portion of the brine stream from the membrane, the outlet from the pump section and the turbine section of the second turbocharger being operatively connected to an inlet on the membrane.

7. The system of claim 6 wherein a first control valve is operatively connected to the inlet for the pump section of the first energy recovery turbocharger to control the flow and pressure of the feed stream from the high pressure pump.

8. The system of claim 6 wherein a second control valve is operatively connected to the inlet for the turbine section of the first energy recovery turbocharger to control the flow and pressure of the first portion of the brine stream.

9. The system of claim 6 wherein a third control valve is operatively connected to the inlet of the turbine section of the second energy recovery turbocharger to control the flow and pressure of the feed stream from the pump section of the first energy recovery turbocharger.

10. A reverse osmosis system having a high pressure pump for pressurizing a feed stream of a fluid and a membrane that separates the feed stream into a purified stream and a brine stream, the invention comprising:
a venturi pump having a first inlet, a second inlet, and an outlet, the first inlet being disposed for receiving a feed stream from the high pressure pump, the outlet being operatively connected to an inlet for the membrane, the venturi pump having a mixing chamber with a first and a second inlet port, and a discharge port, the first inlet port of the mixing chamber being connected to the inlet and disposed to receive the feed stream from the high pressure pump, the second inlet port of the mixing chamber being connected to the second inlet and being disposed to receive a portion of the brine stream from the membrane, the discharge port being connected to a diffuser, the diffuser increases in cross sectional area as it extends away from the mixing chamber to the outlet for the venturi pump, the diffuser being connected to the outlet of the venturi pump.

11. The system of claim 10 wherein a first control valve is operatively connected to the second inlet for the venturi pump to control the flow and pressure of the portion of the brine stream.

12. The system of claim 11 wherein a second control valve is operatively connected to an outlet for the membrane to control the flow and pressure of the brine stream.

13. A reverse osmosis system having a high pressure pump for pressurizing a feed stream of a fluid and a membrane for separating the feed stream into a purified stream and a brine stream, the invention comprising:
an energy recovery turbocharger having a pump section with an inlet and an outlet and a turbine section having an inlet and an outlet, the pump section being operatively connected to the turbine section, the inlet on the turbine section being disposed for receiving a first portion of the brine stream from the membrane, the inlet for the pump section being disposed for receiving the feed stream from the high pressure pump,
a venturi pump having a first inlet, a second inlet, and an outlet, the first inlet being operatively connected to the outlet from the pump section, the venturi pump having a mixing chamber with a first and a second inlet port, and a discharge port, the first inlet port being connected to the first inlet of the venturi pump, the second inlet port being connected to the second inlet and disposed to receive a second portion of the brine stream from the membrane, the discharge port being connected to a diffuser, the diffuser increasing in cross sectional area as it extends from the mixing chamber to the outlet from the venturi pump.

14. The system of claim 13 wherein a first control valve is operatively connected to the second inlet for the venturi pump to control the flow and pressure of the second portion of the brine stream.

15. The system of claim 13 wherein a second control valve is operatively connected to the inlet of the turbine section to control the flow and pressure of the first portion of the brine stream.

16. The system of claim 13 wherein a second energy recovery turbocharger is positioned between the energy recovery turbocharger and the venturi pump, the second turbocharger having a pump section with an inlet and an outlet and, and a turbine section with an inlet and an outlet, the pump section of the second turbocharger being operatively connected to the turbine section, the inlet of the turbine section of the second turbocharger being disposed for receiving the first portion of the brine stream from the membrane, the discharge of the turbine section of the second turbocharger being connected to the inlet of the turbine section of the turbocharger, the inlet on the pump section of the second turbocharger being connected to the outlet of the pump section of the turbocharger, the outlet on the pump section of the second turbocharger being connected to the inlet on the venturi pump.
